(19) United States
(12) Patent Application Publication
(10) Pub. No.: US 2013/0260206 A1
(43) Pub. Date: Oct. 3, 2013

(54) ELECTROCHEMICAL CELL COMPRISING A SULFUR-CONTAINING POLYMER

(71) Applicant: BASF SE, Ludwigshafen (DE)

(72) Inventors: Arnd GARSUCH, Ludwigshafen (DE); Frederick Francois CHESNEAU, St. Leon-Rot (DE); Siegfried Waldvogel, Mainz (DE); Birgit Janza, Mainz (DE)

(73) Assignee: BASF SE, Ludwigshafen (DE)

(21) Appl. No.: 13/851,435

(22) Filed: Mar. 27, 2013

Related U.S. Application Data
(60) Provisional application No. 61/615,913, filed on Mar. 27, 2012.

(51) Int. Cl. H01M 2/16; H01M 2/14

(52) U.S. Cl. CPC H01M 2/1686; H01M 2/145
USPC 429/144; 429/231.95; 429/224; 429/231.8; 29/623.1

(57) ABSTRACT

The present invention relates to electrochemical cells comprising
(A) at least one cathode comprising at least one lithium ion-containing transition metal compound,
(B) at least one anode, and
(C) at least one layer comprising
   (a) at least one sulfur-containing polymer (a) comprising sulfur atoms bound in the form of monovalent thiol groups —SH or thiolate groups —S⁻ or bound as divalent disulfide or polysulfide bridges —(S)ₘ— in which m is an integer from 2 to 8, and
   (b) optionally at least one binder.

The present invention further relates to the use of inventive electrochemical cells, and to lithium ion batteries comprising at least one inventive electrochemical cell.

The present invention relates to electrochemical cells comprising
(A) at least one cathode comprising at least one lithium ion-containing transition metal compound,
(B) at least one anode, and
(C) at least one layer comprising
   (a) at least one sulfur-containing polymer (a) comprising sulfur atoms bound in the form of monovalent thiol groups —SH or thiolate groups —S⁻ or bound as divalent disulfide or polysulfide bridges —(S)ₘ— in which m is an integer from 2 to 8, and
   (b) optionally at least one binder.

The present invention further relates to the use of inventive electrochemical cells, and to lithium ion batteries comprising at least one inventive electrochemical cell.

Storing energy has long been a subject of growing interest. Electrochemical cells, for example batteries or accumulators, can serve to store electrical energy. As of recently, what are called lithium ion batteries have attracted particular interest. They are superior to the conventional batteries in several technical aspects. For instance, they can be used to generate voltages unobtainable with batteries based on aqueous electrolytes.

In this context, an important role is played by the materials from which the electrodes are made, and especially the material from which the cathode is made.

In many cases, lithium-containing mixed transition metal oxides are used, especially lithium-containing nickel-cobalt-manganese oxides with layer structure, or manganese-containing spinels which may be doped with one or more transition metals. However a problem with many batteries remains that of cycling stability, which is still in need of improvement. Specifically in the case of those batteries which comprise a comparatively high proportion of manganese, for example in the case of electrochemical cells with a manganese-containing spinel electrode and a graphite anode, a severe loss of capacity is frequently observed within a relatively short time. In addition, it is possible to detect deposition of elemental manganese on the anode in cases where graphite anodes are selected as counterelectrodes. It is believed that these manganese nuclei deposited on the anode, at a potential of less than 1V vs. Li/Li⁺, act as a catalyst for a reductive decomposition of the electrolyte. This is also thought to involve irreversible binding of lithium, as a result of which the lithium ion battery gradually loses capacity.

WO 2009/033627 discloses a ply which can be used as separator for lithium ion batteries. It comprises a nonwoven and particles which are intercalated into the nonwoven and consist of organic polymers and possibly partly of inorganic material. Such separators can particularly prevent short circuits caused by metal dendrites. However, WO 2009/033627 does not disclose any long-term cycling experiments.

WO 2009/103537 discloses a ply with a base structure having pores, and the ply further comprises a binder which has been crosslinked. In a preferred embodiment, the base structure has been at least partly filled with particles. The plies disclosed can be used as separators in batteries. In WO 2009/103537, however, no electrochemical cells comprising the plies described are produced or examined.

WO 2011/024149 discloses lithium ion batteries which comprise an alkali metal such as lithium between cathode and anode, which acts as a scavenger of unwanted by-products or impurities. Both in the course of production of secondary battery cells and in the course of later recycling of the spent cells, suitable safety precautions have to be taken due to the presence of highly reactive alkali metal.

It was thus an object of the present invention to provide electrical cells which have an improved lifetime and in which, even after several cycles, no deposition of an elemental transition metal, more particularly no deposition of elemental manganese, is observed, or in the course of whose production it is possible to use a scavenger which has a lower level of safety problems than the alkali metals and prolongs the lifetime of the cell to the desired degree.

This object is achieved by an electrochemical cell defined at the outset, which comprises
(A) at least one cathode comprising at least one lithium ion-containing transition metal compound,
(B) at least one anode, and
(C) at least one layer comprising
   (a) at least one sulfur-containing polymer (a) comprising sulfur atoms bound in the form of monovalent thiol groups SH or thiolate groups S⁻ or bound as divalent disulfide or polysulfide bridges —(S)ₘ— in which m is an integer from 2 to 8, and
   (b) optionally at least one binder.

The cathode (A) comprises at least one lithium ion-containing transition metal compound, for example the transition metal compounds LiCoO₂, LiFePO₄ or lithium-manganese spinel which are known to the person skilled in the art in lithium ion battery technology. The cathode (A) preferably comprises, as the lithium ion-containing transition metal compound, a lithium ion-containing transition metal oxide which comprises manganese as the transition metal.

Lithium ion-containing transition metal oxides which comprise manganese as the transition metal are understood in the context of the present invention to mean not only those oxides which have at least one transition metal in cationic form, but also those which have at least two transition metal oxides in cationic form. In addition, in the context of the present invention, the term “lithium ion-containing transition metal oxides” also comprises those compounds which—as well as lithium—comprise at least one non-transition metal in cationic form, for example aluminum or calcium.

In a preferred embodiment, manganese may occur in cathode (A) in the formal oxidation state of +4. Manganese in cathode (A) more preferably occurs in a formal oxidation state in the range from +3.5 to +4.

Many elements are ubiquitous. For example, sodium, potassium and chloride are detectable in certain very small proportions in virtually all inorganic materials. In the context of the present invention, proportions of less than 0.1% by weight of cations or anions are disregarded. A lithium ion-containing mixed transition metal oxide comprising less than 0.1% by weight of sodium is thus considered to be sodium-free in the context of the present invention. Correspondingly, a lithium ion-containing mixed transition metal oxide comprising less than 0.1% by weight of sulfate ions is considered to be sulfate-free in the context of the present invention.

In one embodiment of the present invention, lithium ion-containing transition metal oxide is a mixed transition metal oxide comprising not only manganese but at least one further transition metal.

In one embodiment of the present invention, lithium ion-containing transition metal compound is selected from manganese-containing lithium iron phosphates and preferably from manganese-containing spinels and manganese-containing transition metal oxides with layer structure, especially manganese-containing mixed transition metal oxides with layer structure.

In one embodiment of the present invention, lithium ion-containing transition metal compound is selected from those compounds having a superstoichiometric proportion of lithium.

In one embodiment of the present invention, manganese-containing spinels are selected from those of the general formula (Ia)

LiₐM¹_{b}Mn_{3-a-b}O_{4-d} (Ia)

where the variables are each defined as follows:
0.9≦a≦1.3, preferably 0.95≦a≦1.15,
0≦b≦0.6, for example 0.0 or 0.5,
where, in the case that M¹ selected=Ni, preferably: 0.4≦b≦0.55,
−0.1≦d≦0.4, preferably 0≦d≦0.1.

M¹ is selected from one or more elements selected from Al, Mg, Ca, Na, B, Mo, W and transition metals of the first period of the Periodic Table of the Elements. M¹ is preferably selected from Ni, Co, Cr, Zn, Al, and M¹ is most preferably Ni.

In one embodiment of the present invention, manganese-containing spinels are selected from those of the formula LiNi_{0.5}Mn_{1.5}O_{4-d} and LiMn₂O₄.

In another embodiment of the present invention, manganese-containing transition metal oxides with layer structure are selected from those of the formula (IIa)

Li₁₊ₜM²₁₋ₜO₂ (IIa)

where the variables are each defined as follows:
0≦t≦0.3 and
M² is selected from Al, Mg, B, Mo, W, Na, Ca and transition metals of the first period of the Periodic Table of the Elements, the transition metal or at least one transition metal being manganese.

In one embodiment of the present invention, at least 30 mol % of M² is selected from manganese, preferably at least 35 mol %, based on the total content of M².

In one embodiment of the present invention, M² is selected from combinations of Ni, Co and Mn which do not comprise any further elements in significant amounts.

In another embodiment, M² is selected from combinations of Ni, Co and Mn which comprise at least one further element in significant amounts, for example in the range from 1 to 10 mol % of Al, Ca or Na.

In one embodiment of the present invention, manganese-containing transition metal oxides with layer structure are selected from those in which M² is selected from Ni_{0.33}Co_{0.33}Mn_{0.33}, Ni_{0.5}Co_{0.2}Mn_{0.3}, Ni_{0.4}Co_{0.3}Mn_{0.4}, Ni_{0.4}Co_{0.2}Mn_{0.4} and Ni_{0.45}Co_{0.10}Mn_{0.45}.

In one embodiment, lithium-containing transition metal oxide is in the form of primary particles agglomerated to spherical secondary particles, the mean particle diameter (D50) of the primary particles being in the range from 50 nm to 2 μm and the mean particle diameter (D50) of the secondary particles being in the range from 2 μm to 50 μm.

Cathode (A) may comprise one or more further constituents. For example, cathode (A) may comprise carbon in a conductive polymorph, for example selected from graphite, carbon black, carbon nanotubes, graphene or mixtures of at least two of the aforementioned substances.

In addition, cathode (A) may comprise one or more binders, for example one or more organic polymers. Suitable binders are, for example, organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene, especially styrene-butadiene copolymers. Polypropylene is also suitable. Polyisoprene and polyacrylates are additionally suitable. Particular preference is given to polyacrylonitrile.

Polyacrylonitrile is understood in the context of the present invention to mean not only polyacrylonitrile homopolymers, but also copolymers of acrylonitrile with 1,3-butadiene or styrene. Preference is given to polyacrylonitrile homopolymers.

In the context of the present invention, polyethylene is understood to mean not only homopolyethylene but also copolymers of ethylene which comprise at least 50 mol % of ethylene in copolymerized form and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is understood to mean not only homopolypropylene but also copolymers of propylene which comprise at least 50 mol % of propylene in copolymerized form and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is understood to mean not only homopolymers of styrene but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder is polybutadiene.

Other suitable binders are selected from polyethylene oxide (PEO), cellulose, carboxymethylcellulose, polyimides and polyvinyl alcohol.

In one embodiment of the present invention, binders are selected from those (co)polymers which have a mean molecular weight M_{w} in the range from 50 000 to 1 000 000 g/mol, preferably to 500 000 g/mol.

Binders may be crosslinked or uncrosslinked (co)polymers.

In a particularly preferred embodiment of the present invention, binders are selected from halogenated (co)polymers, especially from fluorinated (co)polymers. Halogenated or fluorinated (co)polymers are understood to mean those (co)polymers comprising, in copolymerized form, at least one (co)monomer having at least one halogen atom or at least one fluorine atom per molecule, preferably at least two halogen atoms or at least two fluorine atoms per molecule.

Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

In addition, cathode (A) may have further constituents customary per se, for example an output conductor, which may be configured in the form of a metal wire, metal grid, metal mesh, expanded metal, metal sheet or a metal foil. Suitable metal foils are especially aluminum foils.

In one embodiment of the present invention, cathode (A) has a thickness in the range from 15 to 200 μm, preferably from 30 to 100 μm, based on the thickness without output conductor.

Inventive electrochemical cells further comprise at least one anode (B).

In one embodiment of the present invention, anode (B) can be selected from anodes composed of carbon and anodes comprising Sn or Si. Anodes composed of carbon can be selected, for example, from hard carbon, soft carbon, graphene, graphite, and especially graphite, intercalated graphite and mixtures of two or more of the aforementioned carbons. Anodes comprising Sn or Si can be selected, for example, from nanoparticulate Si or Sn powder, Si or Sn fibers, carbon-Si or carbon-Sn composite materials, and Si-metal or Sn-metal alloys.

Anode (B) may have one or more binders. The binder selected may be one or more of the aforementioned binders specified in the context of the description of cathode (A).

In addition, anode (B) may have further constituents customary per se, for example an output conductor which may be configured in the form of a metal wire, metal grid, metal mesh, expanded metal, or a metal foil or a metal sheet. Suitable metal foils are especially copper foils.

In one embodiment of the present invention, anode (B) has a thickness in the range from 15 to 200 μm, preferably from 30 to 100 μm, based on the thickness without output conductor.

Inventive electrochemical cells further comprise (C) at least one layer, also called layer (C) for short, which comprises (a) at least one sulfur-containing polymer (a) comprising sulfur atoms bound in the form of monovalent thiol groups SH or thiolate groups —S⁻ or bound as divalent disulfide or polysulfide bridges —(S)ₘ— in which m is an integer from 2 to 8, and (b) optionally at least one binder, also called binder (b) for short.

Preferably, the sulfur-containing polymer (a) present in layer (C), also called polymer (a) for short, comprises those polymer chains which are formed from identical or different monomer units selected from the group consisting of substituted and unsubstituted vinyl units and substituted and unsubstituted C₂-C₁₀-alkylene glycol units and comprise at least one monomer unit -M1- comprising at least one thiol group —SH or thiolate group —S⁻ or at least one end of a disulfide or polysulfide bridge —(S)ₘ— in which m is an integer from 2 to 8, and the thiol group, the thiolate group or the one end of the disulfide or polysulfide bridge —(S)ₘ— is in each case bonded directly to a carbon atom of the monomer unit -M1-. Preferably, polymer (a) consists to an extent of more than 50% by weight, preferably more than 80% by weight and especially to an extent of more than 95% by weight of above-described polymer chains comprising at least one monomer unit -M1-.

In one embodiment of the present invention, in the inventive electrochemical cell, the sulfur-containing polymer (a) present in layer (C) comprises polymer chains which are formed from identical or different monomer units selected from the group consisting of substituted and unsubstituted vinyl units and substituted and unsubstituted C₂-C₁₀-alkylene glycol units and comprise at least one monomer unit -M1- comprising at least one thiol group —SH or thiolate group —S⁻ or at least one end of a disulfide or polysulfide bridge —(S)ₘ— in which m is an integer from 2 to 8, and the thiol group, the thiolate group or the one end of the disulfide or polysulfide bridge —(S)ₘ— is in each case bonded directly to a carbon atom of the monomer unit -M1-.

The polymer chains of polymer (a) which are present in layer (C) of the inventive electrochemical cell are formed from identical or different monomer units selected from the group consisting of substituted and unsubstituted vinyl units and substituted and unsubstituted C₂-C₁₀-alkylene glycol units.

In the case that the polymer chains are formed from different monomer units, the different monomer units within a polymer chain may be randomly distributed or incorporated in blocks, which the person skilled in the art can establish within particular limits through choice of the monomer units and/or of the polymerization process. In principle, polymer (a) may also be a mixture of two separately prepared, different polymers, which are subsequently mixed vigorously, for example with the aid of an extruder, and are generally referred to as polymer blends.

Substituted and unsubstituted vinyl units in polymer chains, or the olefinically unsaturated compounds usable for this purpose in a polymerization, are common knowledge to those skilled in the art. For example, the vinyl unit —CH₂—CHCl— derives from the monomer vinyl chloride, or the vinyl unit —CH₂—CHPh- from the monomer styrene.

The person skilled in the art is likewise aware of polymer chains with substituted and unsubstituted C₂-C₁₀-alkylene glycol units and the monomers customarily used for this purpose in a corresponding polymerization. For example, the ethylene glycol unit —CH₂—CH₂—O— derives from the monomer ethylene oxide, the butylene glycol unit —CH₂—CH₂—CH₂—CH₂—O— derives from the monomer tetrahydrofuran, the substituted ethylene glycol unit —CH₂—CH(CH₂Cl)—O— derives from the monomer epichlorohydrin, and the substituted propylene glycol unit —CH₂—C(CH₂Cl)₂—CH₂—O— derives from the monomer bis(chloromethyl)oxacyclobutane.

The polymer chains of polymer (a) comprise at least one monomer unit -M1- which comprises at least one thiol group —SH or thiolate group —S⁻ or at least one end of a disulfide or polysulfide bridge —(S)ₘ— in which m is an integer from 2 to 8, preferably from 2 to 4, especially 2, and the thiol group, the thiolate group or the one end of the disulfide or polysulfide bridge —(S)ₘ— is in each case bonded directly to a carbon atom of the monomer unit -M1-.

The negative charge of the thiolate group —S⁻ is preferably neutralized by a metal cation Met⁺. In a preferred embodiment, Met⁺ comprises alkali metal cations, half equivalents of alkaline earth metal dications or a half equivalent of a zinc dication, more preferably Li⁺, Na⁺, ½Mg⁺⁺ or ½Zn⁺⁺, especially Li⁺.

In a preferred variant, at least 60%, preferably at least 80%, more preferably at least 95 to a maximum of 100% of the monomer units from which the polymer chains of polymer (a) are formed correspond to the monomer unit -M1-.

In one embodiment of the present invention, in the inventive electrochemical cell, at least 60% of the monomer units from which the polymer chains of the sulfur-containing polymer (a) are formed correspond to the monomer unit -M1-.

Without further restricting the invention, the monomer unit -M1- can be illustrated by the following examples which derive from vinyl units or C₂-C₁₀-alkylene glycol units:

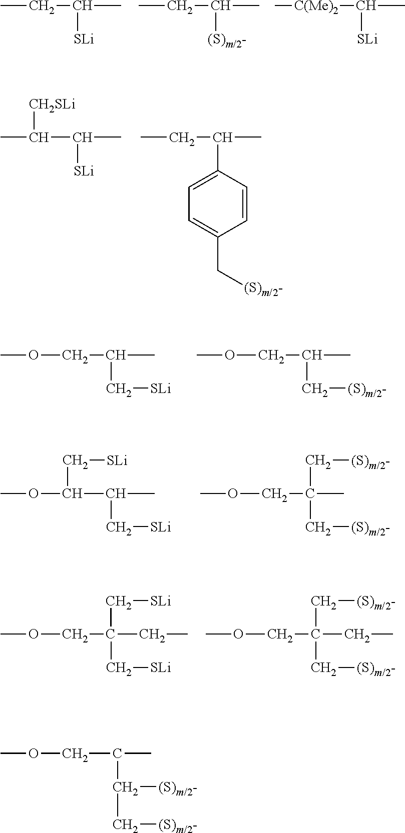

In principle, the monomer units -M1- having a thiolate group could be polymerized directly into the polymer chain by polymerizing the corresponding monomers, in which case the sulfur-containing group in the corresponding monomers would preferably be used in a form capped with a protecting group, which would be removed after the polymerization. Alternatively, proceeding from corresponding polymers which bear suitable leaving groups, for example halogen atoms, it is possible to produce the monomer units -M1- on an existing polymer chain by substitution with suitable sulfur nucleophiles known to those skilled in the art and possibly subsequent reactions.

Monomers which can be converted to polymers and whose halogen atoms can be converted to the monomer units -M1- by subsequent reactions of the finished polymer in what are called polymer-analogous reactions are, for example:

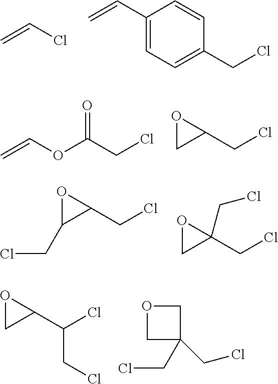

Such polymer-analogous reactions to give sulfur-containing polymers are described, for example, in Modification of Polymers, ACS Symposium Series, Vol. 121, 1980, 41-57 and Reactive Polymers, 8, 1988, 211-220.

In one embodiment of the present invention, in the inventive electrochemical cell, the monomer unit -M1- in the polymer chains of the sulfur-containing polymer (a) is a substituted vinyl unit of the formula (I) and/or of the formula (II)

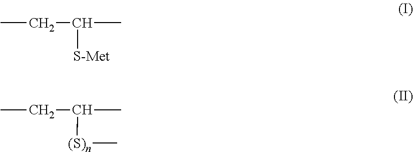

or a substituted ethylene glycol unit of the formula (III) and/or of the formula (IV)

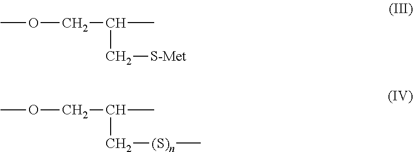

in which Met is H, Li, Na or Zn_{1/2}, especially H, and n is an integer from 1 to 4, especially 1. More preferably, the monomer unit -M1- is a substituted ethylene glycol unit of the formula (III) and/or of the formula (IV), in which Met is H and n is 1.

In one embodiment of the present invention, in the inventive electrochemical cell, the second end of the di- or polysulfide bridge —(S)ₘ— is part of a further monomer unit -M1- which is either in the same polymer chain as the first monomer unit -M1- or in a further polymer chain of the polymer (a). When the di- or polysulfide bridge —(S)ₘ forms between different polymer chains, the result is a polymer crosslinked via di- or polysulfide bridges —(S)ₘ, such crosslinked polymers generally being insoluble, whereas the corresponding individual isolated polymer chains are generally soluble in suitable solvents.

In a further embodiment of the present invention, in the inventive electrochemical cell, the sulfur-containing polymer (a) present in layer (C) comprises polymer chains which are formed from substituted and/or unsubstituted ethylene glycol units as monomer units, where more than 95% up to a maximum of 100% of these monomer units correspond to a monomer unit -M1′-which is a substituted ethylene glycol unit of the formula (III′) and/or of the formula (IV′)

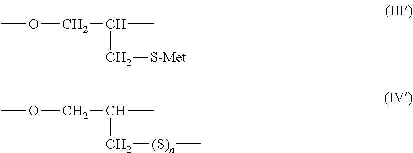

in which Met is H, Li, Na or Zn_{1/2}, especially H, and n is the same or different and is an integer from 1 to 4, especially 1, and two monomer units -M1′- of the formula (IV′) may be joined to one another via a disulfide or polysulfide bridge —(S)ₙ—(S)ₙ—, where these two monomer units -M1′- of the formula (IV′) are either in the same polymer chain or in two different polymer chains.

In a further embodiment of the present invention, in the inventive electrochemical cell, the sulfur-containing polymer (a) present in layer (C) comprises polymer chains which are formed from substituted and/or unsubstituted ethylene glycol units as monomer units, where more than 95% up to a maximum of 100% of these monomer units correspond to a monomer unit -M1′-which is a substituted ethylene glycol unit of the formula (III′) and/or of the formula (IV′)

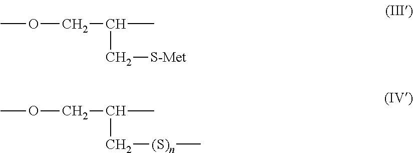

in which Met is H, Li, Na or Zn_{1/2}, especially H, and n is the same or different and is an integer from 1 to 4, especially 1, and two monomer units -M1′- of the formula (IV′) may be joined to one another via a disulfide or polysulfide bridge —(S)ₙ—(S)ₙ—, where these two monomer units M1′- of the formula (IV′) are either in the same polymer chain or in two different polymer chains, polymer (a) having been prepared by a process comprising at least one process step:
a) reaction of a linear polyepichlorohydrin of the formula (V)

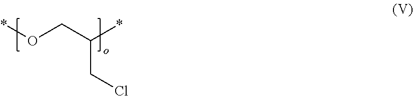

having a molecular weight M_{w} of 100 000 g/mol to 3 000 000 g/mol with thiourea in the presence of a strong aqueous protic acid and of a polar aprotic solvent at a temperature of more than 100° C. and a pressure of more than 1 atm, and subsequent aqueous workup in the presence of atmospheric oxygen to form a polymer comprising monomer units of the formula (III″) and/or of the formula (IV″)

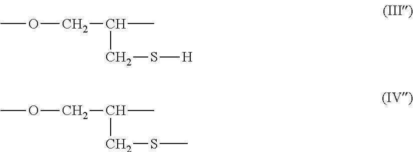

The linear polyepichlorohydrins used in process step a), which have a molecular weight M_{w} of 100 000 g/mol to 3 000 000 g/mol, are known to those skilled in the art and can be purchased commercially. The mean degree of polymerization o in formula (V) for these polymers accordingly ranges from about 1000 to about 33 000.

In process step a), the strong aqueous protic acid used may, for example, be hydrochloric acid, sulfuric acid, hydrobromic acid or perchloric acid. The strong aqueous protic acid used is more preferably hydrochloric acid.

The polar aprotic solvent which can be used in process step a) is, for example, dimethylformamide, N-methyl-2-pyrrolidone, dimethyl sulfoxide, diethyl carbonate or tetramethylurea. The polar aprotic solvent used is more preferably dimethylformamide.

The thiourea is typically used at least in stoichiometric amounts based on the number of chlorine atoms to be substituted. The ratio of thiourea to the chlorine atoms to be substituted is preferably at least 2 to 1, more preferably at least 4 to 1. Typically, the ratio of thiourea to the chlorine atoms to be substituted is not more than 10 to 1, preferably not more than 8 to 1, especially not more than 6 to 1.

Process step a) is performed at a temperature of more than 100° C. and a pressure of more than 1 atm. Typically, process step a) is performed at a temperature of not more than 250° C. Preferably, the reaction in process step a) is performed in a pressure vessel at a temperature between 140 and 160° C.

The reaction time in process step a) typically depends on the reaction temperature and the desired conversion of the reaction. The reaction is preferably performed for a period of 1 day to 5 days.

After the reaction has ended, the reaction product is subsequently subjected to aqueous workup in the presence of atmospheric oxygen, i.e. washed, for example, with water and/or with aqueous hydrochloric acid, to obtain a polymer comprising monomer units of the formula (III″) and/or of the formula (IV″)

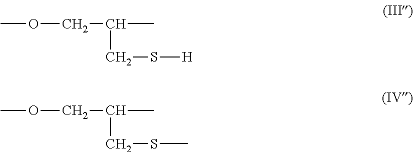

According to the properties of the polymer (a) which is present in layer (C) and has been discussed above, this sulfur-containing polymer (a) may be present in layer (C) in different forms. An insoluble polymer (a) in which various polymer chains are joined to one another, for example by di- or polysulfide bridges, especially disulfide bridges, is preferably incorporated into layer (C) in the form of particles, while a corresponding soluble polymer can be processed to a film or else can be applied homogeneously in layer (C), for example on or in a carrier material which may be of organic or inorganic origin. For example, the separators described in WO 2009/033627 or constituents thereof can be treated, for example impregnated or sprayed, with a solution of a soluble polymer (a), in order to arrive at a modified separator with which an inventive electrochemical cell can be produced. It is also possible to use polymer (a) in particulate form together with the inorganic or organic particles used in WO 2009/033627 for production of correspondingly modified nonwovens. A soluble polymer (a) can be applied, for example, to inorganic particles by impregnation or spraying, especially to oxides selected from the group consisting of SiO₂, Al₂O₃, TiO₂, ZrO₂ and mixtures thereof.

In one embodiment of the present invention, in the inventive electrochemical cells, the polymer (a) present in layer (C) is in particulate form, in the form of a film or homogeneously distributed in layer (C). Preferably, the polymer (a) present in layer (C) is in particulate form. Polymers (a) in particulate form may, in the context of the present invention, have a mean particle diameter (D50) in the range from 0.05 to 100 μm, preferably 0.5 to 10 μm, more preferably 2 to 6 μm.

The proportion by weight of polymer (a) in the total mass of layer (C) may be up to 100% by weight. The proportion by weight of polymer (a) in the total mass of layer (C) is preferably at least 5% by weight. If polymer (a) is applied to an organic or inorganic carrier material, the proportion by weight of polymer (a) in the total mass of layer (C) is more preferably 40 to 80% by weight; more particularly, the proportion by weight of polymer (a) in the total mass of layer (c) is in the range from 30 to 50% by weight.

In one embodiment of the present invention, binder (b) is selected from those binders as described in connection with binders for the cathode(s) (A).

In a preferred embodiment of the present invention, in the inventive electrochemical cell, layer (C) comprises a binder (b) selected from the group of polymers consisting of polyvinyl alcohol, styrene-butadiene rubber, polyacrylonitrile, carboxymethylcellulose and fluorinated (co)polymers, especially selected from styrene-butadiene rubber and fluorinated (co)polymers.

In one embodiment of the present invention, binder (b) and binder for cathode and for anode, if present, are each the same.

In another embodiment, binder (b) differs from binder for cathode (A) and/or binder for anode (B), or binder for anode (B) and binder for cathode (A) are different.

In one embodiment of the present invention, layer (C) has a mean thickness in the range from 0.1 μm to 250 μm, preferably from 1 μm to 50.

Layer (C) is preferably a layer which does not conduct electrical current, i.e. an electrical insulator. On the other hand, layer (C) is preferably a layer which permits the migration of ions, especially of Li⁺ ions. Preferably, layer (C), within the inventive electrochemical cell, is arranged spatially between cathode and anode.

In electrochemical cells, direct contact of the anode with the cathode, which causes a short circuit, is typically prevented by the incorporation of a separator.

In a further embodiment of the present invention, in the inventive electrochemical cells, layer (C) is a separator.

Layer (C) may, as well as the polymer (a) and the optional binder (b), have further constituents, for example support material such as fibers or nonwovens which ensure improved stability of layer (C), without impairing the necessary porosity thereof, ion perviosity thereof and more particularly suitability thereof as an electrical insulator.

In a preferred embodiment of the present invention, in the inventive electrochemical cell, the electrochemical cell comprises, as a further component (D), at least one electrically nonconductive, porous and ion-pervious layer positioned between cathode (A) and layer (C), and at least one electrically nonconductive, porous and ion-pervious layer positioned between anode (B) and layer (C). In this embodiment, an inventive electrochemical cell thus comprises at least two electrically nonconductive, porous and ion-pervious layers, which are also referred to in the context of the present invention for short as layers (D) in the plural or layer (D) in the singular.

In principle, the layers (D) may be the same or different, any difference between two layers (D) being able to be based, for example, on the chemical composition thereof or the specific material properties thereof, such as density, porosity or spatial dimensions, for example thickness, though the enumeration of the potential differences is not conclusive.

Electrically nonconductive, porous and ion-pervious layers are known as such and are already being used, for example, as simple separators in electrochemical cells between cathode and anode.

Layer (D) may, for example, be a nonwoven which may be inorganic or organic in nature, or a porous polymer layer, for example a polyolefin membrane, especially a polyethylene or polypropylene membrane. Polyolefin membranes may in turn be formed from one or more layers. Layer (D) is preferably a nonwoven fabric.

Examples of organic nonwoven fabrics are polyester nonwovens, especially polyethylene terephthalate nonwovens (PET nonwovens), polybutylene terephthalate nonwovens (PBT nonwovens), polyimide nonwovens, polyethylene and polypropylene nonwovens, PVdF nonwovens and PTFE nonwovens.

Examples of inorganic nonwoven fabrics are glass fiber nonwovens and ceramic fiber nonwovens.

The layer (C) present in the inventive electrochemical cell, or the structural unit consisting of layer (C) and two layers (D) aligned in parallel, may also be produced as a semifinished product independently of the construction of the inventive electrochemical cell, and be incorporated later into an electrochemical cell by a battery manufacturer as a finished separator or part of the separator between cathode and anode.

The present invention therefore also further provides a flat separator of layered structure for the separation of a cathode and an anode in an electrochemical cell, comprising
(C) at least one layer, called layer (C) for short, comprising
   (a) at least one sulfur-containing polymer (a) comprising sulfur atoms bound in the form of monovalent thiol groups —SH or thiolate groups —S⁻ or bound as divalent disulfide or polysulfide bridges —(S)ₘ— in which m is an integer from 2 to 8, and
   (b) optionally at least one binder, called binder (b) for short, and
(D) at least two layers which are aligned parallel to one another and are electrically nonconductive, porous and ion-pervious, called layers (D) for short, layer (C) being between two layers (D).

The present invention likewise also provides for the use of a layer (C) comprising
(a) at least one sulfur-containing polymer (a) comprising sulfur atoms bound in the form of monovalent thiol groups SH or thiolate groups —S⁻ or bound as divalent disulfide or polysulfide bridges —(S)ₘ— in which m is an integer from 2 to 8, and
(b) optionally at least one binder,
   as a constituent of a separator which serves for separation of a cathode and an anode in an electrochemical cell.

In the context of the present invention, the expression “flat” means that the separator described, a three-dimensional body, is smaller in one of its three spatial dimensions (extents), namely the thickness, than with respect to the two other dimensions, the length and width. Typically, the thickness of the separator is less than the second-greatest dimension at least by a factor of 5, preferably at least by a factor of 10, more preferably at least by a factor of 20.

Preferred embodiments with regard to layer (C) and the constituents present therein, namely the sulfur-containing polymer (a) and any binder (b) present, and with regard to layers (D), are identical to those described above in connection with the inventive electrochemical cell.

Since the separators are flat, they can not only be incorporated as flat layers between cathode and anode, but can also, as required, be rolled up, wound up or folded as desired.

In one embodiment of the present invention, flat separator of layered structure has a thickness in the range from 5 μm to 250 μm, preferably from 10 μm to 50 μm.

The production of separators with a (D)/(C)/(D) layer structure is known in principle and is described, for example, in WO 2009/033627. The inventive flat separator of layered structure can be produced, for example, in the form of continuous belts which are processed further by the battery manufacturer, more particularly to give an inventive electrochemical cell.

Inventive electrochemical cells may also have constituents customary per se, for example conductive salt, nonaqueous solvent, and also cable connections and housing.

In one embodiment of the present invention, inventive electrochemical cells comprise at least one nonaqueous solvent which may be liquid or solid at room temperature and is preferably liquid at room temperature, and which is preferably selected from polymers, cyclic or noncyclic ethers, cyclic or noncyclic acetals, cyclic or noncyclic organic carbonates and ionic liquids.

Examples of suitable polymers are especially polyalkylene glycols, preferably poly-C₁-C₄-alkylene glycols and especially polyethylene glycols. Polyethylene glycols may comprise up to 20 mol % of one or more C₁-C₄-alkylene glycols in copolymerized form. Polyalkylene glycols are preferably doubly methyl- or ethyl-capped polyalkylene glycols.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (X) and (XI)

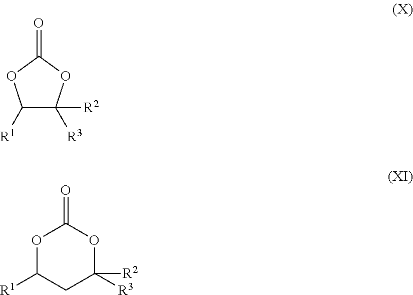

in which R¹, R² and R³ may be the same or different and are each selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (XII).

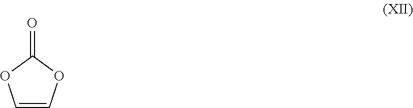

Preference is given to using the solvent(s) in what is called the anhydrous state, i.e. with a water content in the range from 1 ppm to 0.1% by weight, determinable, for example, by Karl Fischer titration.

Inventive electrochemical cells further comprise at least one conductive salt. Suitable conductive salts are especially lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,
m=2 when X is selected from nitrogen and phosphorus, and
m=3 when X is selected from carbon and silicon.

Preferred conductive salts are selected from LiC(CF₃SO₂)₃, LiN(CF₃SO₂)₂, LiPF₆, LiBF₄, LiClO₄, and particular preference is given to LiPF₆ and LiN(CF₃SO₂)₂.

Inventive electrochemical cells further comprise a housing which may be of any shape, for example cuboidal or in the shape of a cylinder. In another embodiment, inventive electrochemical cells have the shape of a prism. In one variant, the housing used is a metal-plastic composite film processed as a pouch.

Inventive electrochemical cells give a high voltage of up to approx. 4.85 V and are notable for high energy density and good stability. More particularly, inventive electrochemical cells are notable for only a very small loss of capacity in the course of repeated cycling.

The present invention further provides for the use of inventive electrochemical cells in lithium ion batteries. The present invention further provides lithium ion batteries comprising at least one inventive electrochemical cell. Inventive electrochemical cells can be combined with one another in inventive lithium ion batteries, for example in series connection or in parallel connection. Series connection is preferred.

The present invention further provides for the use of inventive electrochemical cells as described above in motor vehicles, bicycles operated by electric motor, aircraft, ships or stationary energy stores.

The present invention therefore also further provides for the use of inventive lithium ion batteries in devices, especially in mobile devices. Examples of mobile devices are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The use of inventive lithium ion batteries in devices gives the advantage of prolonged run time before recharging and a smaller loss of capacity in the course of prolonged run time. If the intention were to achieve an equal run time with electrochemical cells with lower energy density, a higher weight for electrochemical cells would have to be accepted.

The invention is explained by the examples which follow, but these do not limit the invention.

Figures in % are each based on % by weight, unless explicitly stated otherwise.

### I. Production of Separators

I.1 Synthesis of Sulfur-Containing Polymer P1

5 g of polyepichlorohydrin (M_{w}=700 000 g/mol, commercially available from Aldrich) were dissolved in 100 ml of DMF with the aid of an agitator overnight. Subsequently, in a pressure tube, thiourea (21 g, 270 mmol) was likewise dissolved in DMF (50 ml) and admixed with the polymer solution and hydrochloric acid (2 M, 15 ml). The resulting viscous mixture was heated to 150° C. for 48 h, in the course of which the formation of a colorless precipitate was observed. The pressure tube was cooled and then opened cautiously. The solids formed were filtered off and washed with water (200 ml), hydrochloric acid (2 M, 100 ml) and water (200 ml). The water-containing solids were frozen at −30° C. and dried on a freeze drier for 48 h. 5.3 g of a colorless powder were isolated. The characterization was effected by means of elemental analysis and ATR-IR.

IR (neat): 2914m, 2867m, 2054w, 1652w, 1461w, 1409w, 1342w, 1093s, 561m cm⁻¹.

| | calculated as | calculated | |
|---|---|---|---|
| Elemental analysis | isothiuronium salt | as hydrolysis product | found |
| Nitrogen | 16.61% | 00.00% | 1.14% |
| Carbon | 28.49% | 40.42% | 39.91% |
| Hydrogen | 5.38% | 5.65% | 6.47% |
| Sulfur | 19.01% | 35.97% | 34.26% |

### I.2 Production of an Inventive Separator S.1

Disks of diameter 12 mm were punched out of a glass fiber nonwoven (Whatman, 260 μm thickness) and dried in a drying cabinet at 120° C. for several hours. Thereafter, the glass fiber nonwoven disks were transferred to an argon-filled glovebox. Each glass fiber nonwoven disk was divided into two parts, such that one glass fiber nonwoven disk gave two glass fiber nonwoven disks each of thickness approx. 130 μm.

The sulfur-containing polymer P1 was placed between the two glass fiber nonwoven disks in powder form (without binder) and distributed homogeneously with a spatula/doctor knife. The areal loading was 12 mg/cm² of sulfur-containing polymer. This gave separator S.1, which was in the form of a sandwich (S polymer between two glass fiber nonwoven disks).

### I.3 Provision of a Noninventive Separator C-S.2

Disks of diameter 12 mm were punched out of a glass fiber nonwoven (Whatman, 260 μm thickness) and dried in a drying cabinet at 120° C. for several hours. This gave comparative separator C-S.2. Thereafter, the glass fiber nonwoven disks were transferred to an argon-filled glovebox.

### II. Production of Electrochemical Cells and Testing Thereof.

The following electrodes were always used:

Cathode (A.1): a lithium-nickel-manganese spinel electrode was used, which was produced as follows. The following were mixed with one another in a screw-top vessel:

### 85% LiMn_{1.5}Ni_{0.5}O₄,

6% PVdF, commercially available as Kynar Flex® 2801 from the Arkema Group,
6% carbon black, BET surface area 62 m²/g, commercially available as “Super P Li” from Timcal,
3% graphite, commercially available as KS6 from Timcal.

While stirring, a sufficient amount of N-methylpyrrolidone was added to obtain a viscous paste free of lumps. The mixture was stirred for 16 hours.

Then the paste thus obtained was knife-coated onto 20 μm-thick aluminum foil and dried in a vacuum drying cabinet at 120° C. for 16 hours. The thickness of the coating after drying was 30 μm. Subsequently, circular disk-shaped segments were punched out, diameter: 12 mm.

Anode (B.1): The following were mixed with one another in a screw-top vessel:

91% graphite, ConocoPhillips C5
6% PVdF, commercially available as Kynar Flex® 2801 from the Arkema Group,
3% carbon black, BET surface area 62 m²/g, commercially available as “Super P Li” from Timcal.

While stirring, a sufficient amount of N-methylpyrrolidone was added to obtain a viscous paste free of lumps. The mixture was stirred for 16 hours.

Then the paste thus obtained was knife-coated onto 20 μm-thick copper foil and dried in a vacuum drying cabinet at 120° C. for 16 hours. The thickness of the coating after drying was 35 μm. Subsequently, circular disk-shaped segments were punched out, diameter: 12 mm.

The following electrolyte was always used:

1 M solution of LiPF₆ in anhydrous ethylene carbonate-ethyl methyl carbonate mixture (proportions by weight 1:1)

### II.1 Production of an Inventive Electrochemical Cell EC.1 and Testing

The inventive separator (S.1) produced according to 1.2 was used as a separator and, for this purpose, electrolyte was dripped onto it in an argon-filled glovebox and it was positioned between a cathode (A.1) and an anode (B.1) such that both the anode and the cathode had direct contact with the separator. Electrolyte was added to obtain inventive electrochemical cell EC.1. The electrochemical analysis was effected between 4.25 V and 4.8 V.

The first two cycles were run at 0.2 C rate for the purpose of forming; cycles no. 3 to no. 50 were cycled at 1 C rate, followed again by 2 cycles at 0.2 C rate, followed by 48 cycles at 1 C rate, etc. The charging and discharging of the cell was performed with the aid of a “MACCOR Battery Tester” at room temperature.

It was found that the battery capacity remained very stable over the course of the repeated charging and discharging.

### II.2 Production of a Noninventive Electrochemical Cell C-EC.2 and Testing

Analogously to example II.1, the separator C-S.2 was used to produce the noninventive electrochemical cell C-EC.2, and it was tested correspondingly.

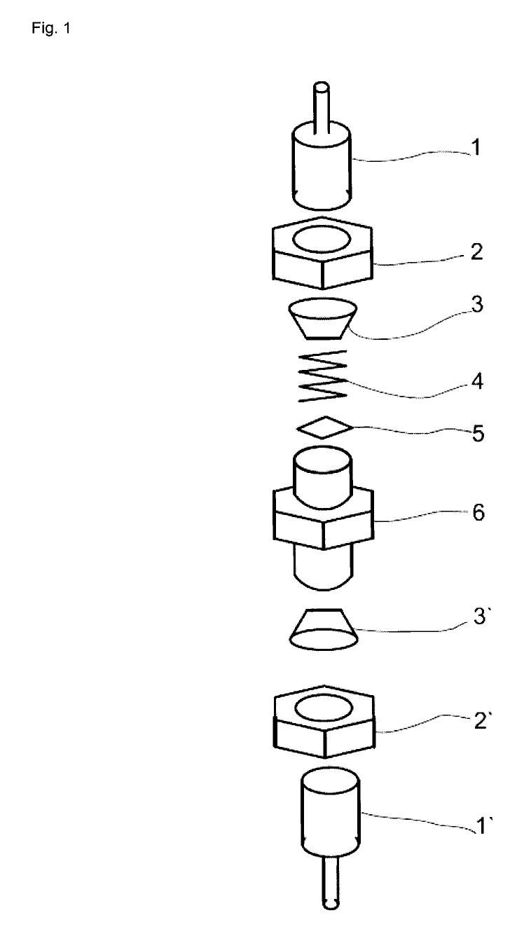

FIG. 1 shows the schematic structure of a dismantled electrochemical cell for testing of inventive and noninventive separators.

The annotations in FIG. 1 mean:
1, 1′ bolts
2, 2′ nuts
3, 3′ sealing ring two in each case, the second, somewhat smaller sealing ring in each case is not shown here
4 spiral spring
5 output conductor made from steel
6 housing

TABLE 1
Test results of inventive and noninventive electrochemical cells

| | Capacity | Capacity | Capacity | |
|---|---|---|---|---|
| | cycle 2 | cycle 100 | cycle 200 | Capacity loss in % |
| Example | [mAh] | [mAh] | [mAh] | after 200 cycles |
| EC. 1 | 125 | 97 | 86 | 31 |
| C-EC. 2 | 127 | 90 | 54 | 58 |

1. An electrochemical cell, comprising:
(A) a cathode comprising a lithium ion-comprising transition metal compound,
(B) an anode, and
(C) a layer, comprising a sulfur-comprising polymer comprising monovalent thiol groups —SH, thiolate groups —S⁻, or divalent disulfide or polysulfide bridges —(S)ₘ— in which m is an integer from 2 to 8,
wherein the layer (C) optionally further comprises a binder.

2. The electrochemical cell according to claim 1, wherein the lithium ion-comprising transition metal compound is a manganese-comprising spinel or a manganese-comprising transition metal oxide with layer structure.

3. The electrochemical cell according to claim 1, wherein the anode (B) is an anode comprising carbon or an anode comprising Sn or Si.

4. The electrochemical cell according to claim 1,
wherein the sulfur-comprising polymer comprises polymer chains comprising at least one monomer unit independently selected from the group consisting of a substituted or unsubstituted vinyl unit and a substituted or unsubstituted C₂-C₁₀-alkylene glycol unit,
the polymer chains comprise a monomer unit -M1- comprising a thiol group —SH, a thiolate group —S⁻, or an end of a disulfide or polysulfide bridge —(S)ₘ— in which m is an integer from 2 to 8, and
the thiol group, the thiolate group or the end of the disulfide or polysulfide bridge —(S)ₘ— is in each case bonded directly to a carbon atom of the monomer unit -M1-.

5. The electrochemical cell according to claim 4, wherein at least 60% of monomer units of the polymer chains are each a monomer unit -M1-.

6. The electrochemical cell according to claim 4,
wherein the monomer unit -M1- is a substituted vinyl unit of formula (I) or of formula (II) or a substituted ethylene glycol unit of formula (III) or of formula (IV): 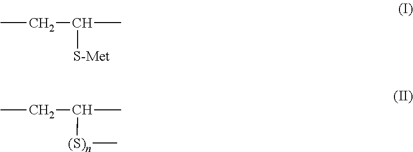 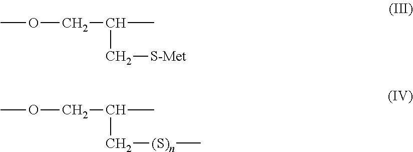
Met is H, Li, Na or Zn_{1/2}, and
each n is independently an integer from 1 to 4.

7. The electrochemical cell according to claim 4, wherein a second end of the di- or polysulfide bridge —(S)ₘ— is part of a further monomer unit -M1- which is either in the same polymer chain as the first monomer unit -M1- or in a further polymer chain of the sulfur-comprising polymer.

8. The electrochemical cell according to claim 1,
wherein the sulfur-comprising polymer comprises polymer chains comprising substituted ethylene glycol units, unsubstituted ethylene glycol units, or both as monomer units,
more than 95% of the substituted ethylene glycol units, unsubstituted ethylene glycol units, or both are each a monomer unit -M1′- which is a substituted ethylene glycol unit of formula (III′) or of formula (IV′): 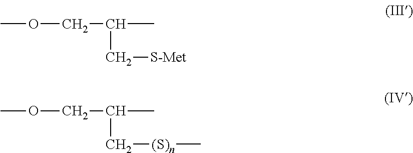
Met is H, Li, Na, or Zn_{1/2},
each n is independently an integer from 1 to 4, and
two monomer units -M1′- of formula (IV′) in the same polymer chain or in two different polymer chains are optionally joined to one another via a disulfide or polysulfide bridge —(S)ₙ—(S)ₙ.

9. The electrochemical cell according to claim 1,
wherein the sulfur-comprising polymer comprises polymer chains which comprise substituted ethylene glycol units, unsubstituted ethylene glycol units, or both as monomer units,
more than 95% of the substituted ethylene glycol units, unsubstituted ethylene glycol units, or both are each a monomer unit -M1′- which is a substituted ethylene glycol unit of formula (III′) or of formula (IV′): 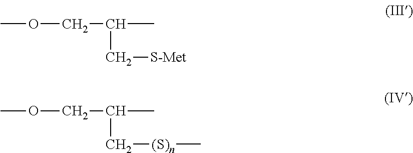
Met is H, Li, Na or Zn_{1/2},
each n is independently an integer from 1 to 4,
two monomer units -M1′- of formula (IV′) in the same polymer chain or in two different polymer chains are optionally joined to one another via a disulfide or polysulfide bridge —(S)ₙ(S)ₙ, and
the sulfur-comprising polymer is obtained by a process comprising reacting a linear polyepichlorohydrin with thiourea in the presence of a strong aqueous protic acid and of a polar aprotic solvent at a temperature of more than 100° C. and a pressure of more than 1 atm, and subsequently working up, in an aqueous workup in the presence of atmospheric oxygen, thereby obtaining a polymer comprising monomer units of formula (III″) or of formula (IV″) 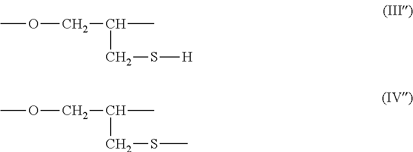
the linear polyepichlorohydrin is a linear polyepichlorohydrin of formula (V): 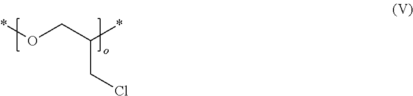
having a molecular weight M_{w} of from 100 000 g/mol to 3 000 000 g/mol.

10. The electrochemical cell according to claim 1, wherein the layer (C) comprises a binder selected from the group of polymers consisting of polyvinyl alcohol, styrene-butadiene rubber, polyacrylonitrile, carboxymethylcellulose, and a fluorinated (co)polymer.

11. The electrochemical cell according to claim 1, wherein the layer (C) has a mean thickness of from 1 to 50 μm.

12. The electrochemical cell according to claim 1, wherein the layer (C) is a separator.

13. The electrochemical cell according to claim 1, wherein the electrochemical cell further comprises:
an electrically nonconductive, porous and ion-pervious layer between the cathode (A) and the layer (C), and
an electrically nonconductive, porous, and ion-pervious layer between the anode (B) and the layer (C).

14. A method of manufacturing a lithium ion battery, the method comprising:
manufacturing a lithium ion battery comprising the electrochemical cell according to claim 1.

15. A lithium ion battery comprising the electrochemical cell according to claim 1.

16. A motor vehicle, a bicycle operated by electric motor, an aircraft, a ship, or a stationary energy store, comprising the electrochemical cell according to claim 1.

17. A flat separator of layered structure, comprising:
(C) a layer (C) comprising a sulfur-comprising polymer comprising monovalent thiol groups —SH, thiolate groups —S⁻, or divalent disulfide or polysulfide bridges —(S)ₘ— in which m is an integer from 2 to 8, and
(D) two electrically nonconductive, porous, and ion-pervious layers (D) aligned parallel to one another,
wherein the layer (C) is between the two layers (D),
the layer (C) optionally further comprises a binder, and
the separator is suitable for separation of a cathode and an anode in an electrochemical cell.

18. A method of manufacturing a separator, the method comprising:
manufacturing a separator comprising a layer (C),
wherein the layer (C) comprises a sulfur-comprising polymer comprising monovalent thiol groups —SH, thiolate groups —S⁻, or divalent disulfide or polysulfide bridges —(S)ₘ— in which m is an integer from 2 to 8,
the separator is suitable for separation of a cathode and an anode in an electrochemical cell, and
the layer (C) optionally further comprises a binder.
